(19) United States
(12) Patent Application Publication
(10) Pub. No.: US 2008/0122619 A1
(43) Pub. Date: May 29, 2008

(54) Method For Complicating The Theft Of Shopping Trolleys

(75) Inventor: Herbert Eberlein, Bubesheim (DE)

Correspondence Address: BUCHANAN, INGERSOLL & ROONEY PC, POST OFFICE BOX 1404, ALEXANDRIA, VA, 22313-1404, US

(73) Assignee: WANZL METALLWARENFABRIK GMBH, Leipheim (DE)

(21) Appl. No.: 11/575,516

(22) PCT Filed: Jul. 13, 2005
(86) PCT No.: PCT/DE05/01236

§ 371 Date: Sep. 26, 2007

(30) Foreign Application Priority Data
Sep. 20, 2004 (DE) 10 2004 045 842.1

(51) Int. Cl. G08B 13/14; G08B 13/24

(52) U.S. Cl. 340/568.1

(57) ABSTRACT

A method for complicating the theft of shopping trolleys (11) which are made available to customers in self-service stores (1). Every shopping trolley (11) is provided with a transponder (12) having the same identification key. At least one monitoring device (14) corresponding with the transponders (120 of the shopping trolleys (11) is provided in at least one suitable position of an exterior area (2) pertaining to the self-service store (1), for example a customer car park (4). When the shopping trolley (11) passes the monitoring device (14), the monitoring device (14) changes the identification key of the transponder (12) of said shopping trolley (11) to a new identification key. When a shopping trolley (11) having a changed identification key passes a predetermined position (10) inside the self-service store (1), a check device (13) associated with the predetermined position (10) changes the changed identification key back to its original identification key, and the change-back process effected by the check device (13) triggers a signal.

The invention relates to a method of impeding the theft of shopping trolleys which are made available to customers in self-service stores, wherein each shopping trolley is provided with a transponder having the same identification key and wherein at least one monitoring device associated with the transponders of the shopping trolleys is provided in at least one suitable position in an exterior area belonging to the self-service store, for example a customer car park.

The desire to prevent or at least limit the theft of shopping trolleys from self-service stores is not new. As early as 1960, a proposed solution to this problem was described in U.S. Pat. No. 2,964,140. In the meantime, at least fifty further applications dealing with the aforementioned problem have entered patent literature. The most recently proposed solution is documented in EP 1 101 685 A1. All the proposed solutions formulated within this time period employ at least one of the following technical features:
magnetic locking of the casters of the shopping trolleys upon leaving a predesignated area;
radio-operated locking of the casters upon leaving this area;
changing the position of at least one caster by causing the shopping trolleys to be raised by obstacles;
obstacles which are located in the zone of operation and impede further movement of the shopping trolleys;
operation of locking arms which prevent movement of the casters;
generation of rolling resistances upon leaving a predesignated area.

All the above-described proposals necessitate more or less expensive modifications to the shopping trolleys and, in some cases, also additional modifications in the region of the ground. Some of the solutions are simply impractical. Others lead to a considerable increase in the cost of manufacturing the shopping trolleys, with the result that the demand for such shopping trolleys is inevitably low.

In consideration of these disadvantages, it has been proposed in the meantime to provide shopping trolleys with a transponder and to install monitoring devices at the exits which lead from the site of a self-service store to the adjacent streets, which monitoring devices then emit a loud signal if somebody tries to walk past a monitoring device with a shopping trolley. In addition, it has also been proposed, instead of the monitoring device, to provide each shopping trolley with a signal transmitter. This solution likewise does not carry conviction because these shopping trolleys only attract attention when they are already relatively far away from the self-service store. It would therefore be necessary for staff to be posted permanently in these outer zones; the staff would then have to intervene every time somebody tried to take away or steal a shopping trolley. This is unrealistic.

The motives which led to the above-described solutions being proposed in the past may have been entirely different. What has remained unchanged in the meantime is that most shopping-trolley thefts are committed by persons who live in the immediate vicinity of self-service stores and who, through lack of a car, have to go shopping on foot. These persons simply push the goods-laden shopping trolley home and only come back again with the shopping trolley to the self-service store when further purchases are required.

On the basis of this knowledge, the object of the invention is to develop further a method of the present type so that the initially described disadvantages or inconveniences are avoided.

To achieve this object, it is provided that, when a shopping trolley passes the monitoring device, the monitoring device changes the identification key of the transponder of this shopping trolley to a new identification key and, when a shopping trolley having a changed identification key passes a predetermined point inside the self-service store, a checking device associated with the predetermined point restores the changed identification key to its original identification key, wherein the restoration process effected by the checking device triggers a signal.

The proposed method advantageously avoids the mounting or installation of locking and/or braking devices on the casters of the shopping trolleys. It avoids all devices which would be necessary to effect locking or braking of the casters. It also avoids costly modification of the shopping trolleys. The new method does not require obstacles in the ground or magnetically acting components which have to be disposed on the ground.

Instead, in the method according to the invention, it is sufficient for a transponder of minimal size simply to be mounted on each shopping trolley, wherein these transponders are, for example, to be inserted or injection-moulded into a plastics part already provided on the shopping trolley, which is simple from the point of view of manufacture and therefore inexpensive to implement. The latter is of major importance because shopping trolleys are used in large numbers. Naturally, at least one electronically acting, radio-operated monitoring device and at least one likewise electronically acting, radio-operated checking device have to be provided, although this is simple to implement from a structural point of view. For example, each of the relatively small-size monitoring devices can be installed at a respective exit on the site of the self-service store and each likewise small-size checking device can be installed e.g. in a respective aisle leading past a cash register in the self-service store, wherein each checking device, as will be further described hereinbelow, can be electrically connected to a cash register. The at least one monitoring device and the at least one checking device can even have the same design and only be differently programmed, thereby contributing towards inexpensive installation of the above-described devices.

The invention will be further described with reference to a schematic drawing and a method sequence.

The drawing shows a plan view of a self-service store 1 with an adjacent exterior area 2 which, in the example, is formed as a customer car park 4. A collection point 5 for shopping trolleys 11 is located in the customer car park 4. The shopping trolleys 11 are usually coupled together here by means of coin-operated locks and are normally removed from the collection point 5 upon payment of a deposit and returned to the collection point 5 after the shopping has been completed. The drawing shows a shopping trolley 11 of this type, which is provided with a radio-operated electric storage medium, i.e. a so-called transponder 12. The self-service store 1 has an entrance area 6 which is adjoined by the sales floor 7. The sales floor 7 ends at the so-called check-out area 8. The check-out area 8 has at least one aisle 9 which is intended for customers and their shopping trolleys 11 and which are each provided with an electronic cash register 15. Two aisles 9 are provided in the example. At two predetermined points 10, preferably in each aisle 9, a respective checking device 13 in the form of an electronic read/write unit transmitting radio waves is provided. An electronic read/write unit in the form of a monitoring device 14 transmitting substantially the same radio waves is also provided in the exterior area 2 at an exit 3 leading e.g. to a street. It is entirely possible for a plurality of exits 3 to be provided, with each of which a monitoring device 14 is then associated. Each transponder 12 of the shopping trolleys 11 is provided with an identification key (for example A) which can be picked up by radio and controlled by each checking device 13 and each monitoring device 14.

When a customer goes shopping in the self-service store 1, he takes a shopping trolley 11 from the collection point 5, passes through the entrance area 6 and then selects goods from the sales floor 7. To pay for the goods, the customer steps into one of the aisles 9 with his shopping trolley 11, pays for his shopping, goes with the shopping trolley 11 to his car, where he unloads the shopping trolley 11, and brings the now empty shopping trolley 11 back to the collection point 5. As the customer passes through the aisle 9, the checking device 13 arranged there registers the identification key of the transponder 12 of the shopping trolley 11 moving past. The above-described sequence corresponds to the usual known shopping procedure. It is not usual if a customer, after paying for his shopping, makes his way home on foot with the goods-laden shopping trolley 11. In this case, the customer passes through the exit 3 from the exterior area 2 with his shopping trolley 11. The monitoring device 14 at the exit 3 is programmed so that it detects by radio the identification key of the transponder 12 of the shopping trolley 11 moving past and then changes it e.g. from A to B. From this moment, this “stolen” shopping trolley 11 differs from the other shopping trolleys 11 used in the self-service store 1 in that it has a different or new identification key. If the customer returns at some point to the self-service store 1 with his “purloined” shopping trolley 11 for the next shopping trip, he has to pass through one of the aisles 9 again having completed his shopping in order to be able to pay for his goods. The checking device 13 associated with this aisle 9 is programmed so that it detects the changed identification key of the shopping trolley 11, designated as stolen, as it moves past and changes it back to the original identification key, e.g. A. This modification of the identification key triggers a perceptible signal which originates from a signal transmitter electrically connected to the checking device 13. Ideally, each checking device 13 is electrically connected or linked to the cash register 15 associated with it via the corresponding aisle 9. In this way, each cash register 15 assumes the role of a signal transmitter, for example in such a way that the signal appears on the printed till receipt in the form of the instruction: “please park the shopping trolley at the collection point”. This manner of instruction is discreet and does not draw attention to the customer in the self-service store 1. Independently of this, it is also possible to use the selected “signal” either so that selected members of staff of the self-service store 1 personally ask the customer on the spot not to take the shopping trolley 11 with him or so that this customer, at the latest when passing through the exit 3 again with the shopping trolley 11, is stopped by the members of staff and enlightened accordingly with respect to his behaviour.

According to a development of the invention, it is also possible to mount a checking device 13 at the collection point 5 for shopping trolleys 11. Should someone have left the exterior area 2 with the shopping trolley 11 through the exit 3 and want to come back immediately in order to return the shopping trolley 11 to the collection point 5, the checking device 13 at the collection point 5 would then restore the changed identification key of the shopping trolley 11 to the original identification key.

1. A method of impeding the theft of shopping trolleys which are made available to customers in self-service stores, the method comprising:
providing each shopping trolley with a transponder having a same identification key; and
providing at least one monitoring device associated with the transponders of the shopping trolleys in at least one suitable position in an exterior area belonging to the self-service store;
wherein when a shopping trolley passes the monitoring device, the monitoring device changes the identification key of the transponder of the shopping trolley to a new identification key and, when a shopping trolley having a changed identification key passes a predetermined point inside the self-service store, a checking device associated with the predetermined point restores the changed identification key to its original identification key and triggers a signal.

2. the method according to claim 1, wherein the signal is triggered by a cash register which is electrically connected to the checking device.

3. A method according to claim 1, wherein the signal appears as a written instruction on the till receipt.

4. method according to claim 1, wherein restoration of the identification key of a shopping trolley can also be carried out by a checking device provided at the collection point for the shopping trolleys.
